(19) United States
(12) Patent Application Publication
(10) Pub. No.: US 2018/0009501 A1
(43) Pub. Date: Jan. 11, 2018

(54) DYNAMIC FORCE-DISTRIBUTING DEVICE AND ITS APPLICATION TO THE SINGLE-HANDED BRAKING DEVICE OF FRONT AND REAR WHEELS

(71) Applicant: FONG-CHYI CHANG, Taichung (TW)

(72) Inventor: FONG-CHYI CHANG, Taichung (TW)

(73) Assignee: FONG-CHYI CHANG, Taichung (TW)

(21) Appl. No.: 15/547,519

(22) PCT Filed: Jan. 30, 2015
(86) PCT No.: PCT/CN2015/071949

§ 371 Date: Jul. 31, 2017

(51) Int. Cl. B62L 3/08; B60T 17/08; B60T 11/08; B60T 7/10; B60T 11/04; B60T 8/26; B62L 3/02; B60T 11/20

(52) U.S. Cl. CPC B62L 3/08; B62L 3/023; B60T 17/08; B60T 11/206; B60T 7/102; B60T 11/046; B60T 8/26; B60T 11/08

(57) ABSTRACT

The invention relates to a dynamic force-distributing device. The dynamic force-distributing device has a dynamic three-stage force distribution function, and is especially suitable for being applied to a single-handed braking device of various front and rear wheel form vehicles. The whole braking process can show three-stage functional characteristics such as safety, stability, reliability, fast stopping and the like, so that the problem of accidents caused by improper brake operation is avoided.

### CROSS-REFERENCES TO RELATED APPLICATIONS

The present application claims priority to PCT application number PCT/CN2005/071949, filed on 2015 Jan. 30, which is incorporated by reference in its entirety.

### BACKGROUND

The present application relates to a dynamic force-distributing device. The dynamic force-distributing device (hereinafter referred to as “a force-distributing device” for short) has a dynamic three-stage strength distribution function, and is especially suitable for being applied to a single-handed brake device of various front and rear wheel form vehicles. The whole braking process can show three-stage functional characteristics such as safety, stability, reliability, fast stopping and the like, so that the problem of accidents caused by improper brake operation is avoided.

Since the vehicles are commonly used in various front and rear wheel forms, such as bicycles, due to the fact that the front wheel is firstly braked in emergency, the casualty accidents are never avoided, while there are a few applications of brake control devices for preventing such emergency brake accidents, however, the design of these applications has certain specific defects, the defects include that a proper front wheel brake force and a rear wheel brake force cannot be directly and effectively distributed, and the structure is too complex, the operation is delayed or distorted, the production cost is too high, and the replacement or assembly is not easy, the service life is short, the preset use condition is too strict, and the appearance and the assembling mode of the product are poor, the hand feeling and the stability of the brake process are poor, and the like. Therefore, there is still no application to be commonly accepted and used by most vehicles, and the accidents are still happened frequently.

### SUMMARY

The defects of the prior art for preventing bike's emergency brake accidents are overcome, the invention discloses a force-distributing device, so that the proportion of the brake force distribution of the front wheel and the rear wheel of the whole brake process can be changed dynamically, stable and reliable, and the function characteristics of three different stages such as safety, stability, reliability and fast stopping are achieved. The single-hand brake control device is simple and durable in structure, low in cost and expected to be widely applied to a single-hand brake control device of a front-back wheel vehicle, the problem that casualties are easily caused due to improper brake operation of a rider is effectively solved, and a high practical value is created.

### BRIEF DESCRIPTION OF THE DRAWINGS

FIG. 1 and FIG. 2 are exploded and assembled diagrams of the first structural type of force-distributing device (using a sliding pivotal rod).

FIG. 3 and FIG. 4 are exploded and assembled diagrams of first and second embodiments.

FIG. 5 and FIG. 6 are exploded and assembled diagrams of the first structural type of force-distributing device (using a rolling pivotal rod).

FIG. 7 is a diagram schematically illustrating the three-stage force distribution function of the first structural type of force-distributing device.

FIG. 8 is a three-stage force distribution function graph of the force-distributing device applied to front brake and rear brake.

FIG. 9 and FIG. 10 are exploded and assembled diagrams of the first structural type of force-distributing device (using a rotating arm pivotal rod).

FIG. 11 and FIG. 12 are exploded and assembled diagrams of the first structural type of force-distributing device (using a rotating body pivotal rod).

FIG. 13 is a diagram schematically illustrating the three-stage force distribution function of the second structural type of force-distributing device.

FIG. 14 is a diagram schematically illustrating the third embodiment.

FIG. 15 is a diagram schematically illustrating the fourth embodiment.

FIG. 16 is a diagram schematically illustrating the fifth embodiment.

FIG. 17 is a diagram schematically illustrating the sixth embodiment.

FIGS. 18, 19 and 20 are diagrams schematically illustrating the applicable methods to adjust the forces to be distributed.

FIG. 21 and FIG. 22 are diagrams schematically illustrating the structural integration of the brake levers.

### LABEL NO - - - NAME

1 - - - force-distributing device
10 - - - frame assembly
101 - - - fixed section
12 - - - cable adjustment screw assembly
15 - - - connecting hole
20 - - - brake lever
201 - - - lever force output hole
202 - - - lever shaft hole
30 - - - frame
301 - - - rod moving space
306 - - - rotate restrict convex
307 - - - spring attachment hole
308 - - - screw
309 - - - parallel perforation
31 - - - compression spring
33 - - - torsion spring
34 - - - rotating arm
343 - - - rotating arm shaft
36 - - - rotating body
362 - - - rotate restrict concave
363 - - - spring attachment part
40 - - - force input moving piece
401 - - - movable force-in pivotal rod
402 - - - perforated movable body
42 - - - brake force input cable
50 - - - first force output of moving piece (front wheel)
501 - - - first force output shaft (front wheel)
52 - - - front brake cable
53 - - - front brake hydraulic piston rod
54 - - - front brake hydraulic cylinder
55 - - - front brake hydraulic pipe
60 - - - second force output of moving pieces (rear wheel)
601 - - - second force output shaft (rear wheel)
62 - - - rear brake cable
63 - - - rear brake hydraulic piston rod
64 - - - rear brake hydraulic cylinder
65 - - - rear brake hydraulic pipe
70 - - - handlebar
80 - - - existing cable brake lever assembly
81 - - - existing cable fastener
82 - - - existing brake lever
83 - - - existing cable adjustment screw assembly
84 - - - existing brake cable housing

### DETAILED DESCRIPTION OF THE PREFERRED EMBODIMENTS

The force-distributing device and its applications to single-handed brake lever of front and rear wheels are simple in structure. The first structural type of the force-distributing device is called “surface moving pivotal rod type” (including “sliding pivotal rod type” and “rolling pivotal rod type”, and both types have the same physical theory). The second structural type is “rotating pivotal rod type” (including “rotating arm pivotal rod type” and “rotating body pivotal rod type”, and both types have the same physical theory). Both of the two structural types of force-distributing device can be applied to “cable brake lever” assembly, “hydraulic brake lever” assembly and “cable brake breakout box” assembly for the single-handed front and rear wheels brake. Therefore, it can be applied to six types of embodiment in total:

The first type of embodiment apply a “surface moving pivotal rod type” force-distributing device to a “cable brake lever” assembly.

The second type of embodiment apply a “rotating pivotal rod type” force-distributing device to a “cable brake lever” assembly.

The third type of embodiment apply a “surface moving pivotal rod type” force-distributing device to a “hydraulic brake lever” assembly.

The fourth type of embodiment apply a “rotating pivotal rod type” force-distributing device to a “hydraulic brake lever” assembly.

The fifth type of embodiment apply a “surface moving pivotal rod type” force-distributing device to a “cable brake breakout box” assembly.

The sixth type of embodiment apply a “rotating pivotal rod type” force-distributing device to a “cable brake breakout box” assembly.

All six embodiments can provide the safe three-stage brake function while the brake force is applied to from zero to maximum.

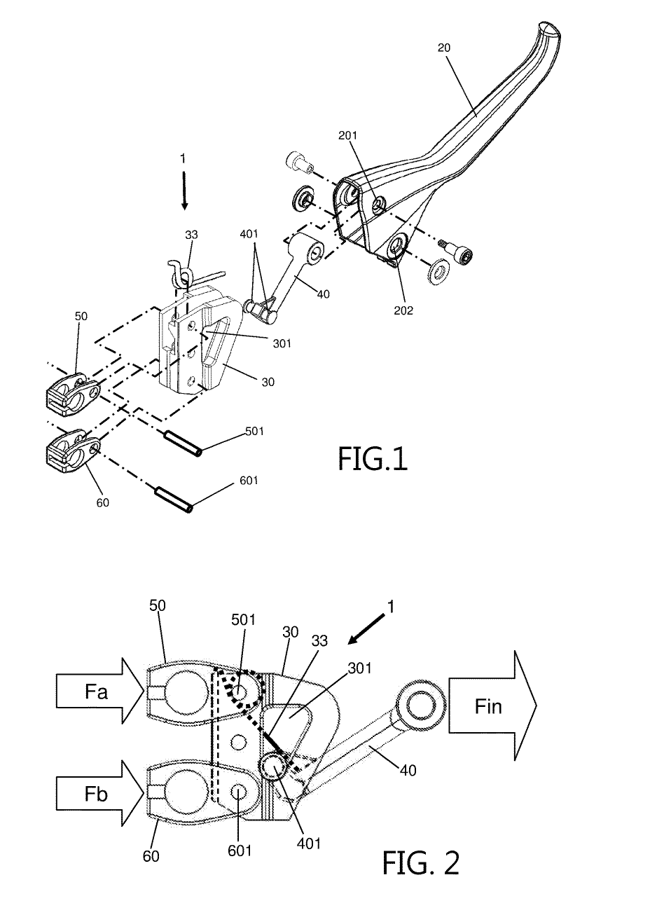

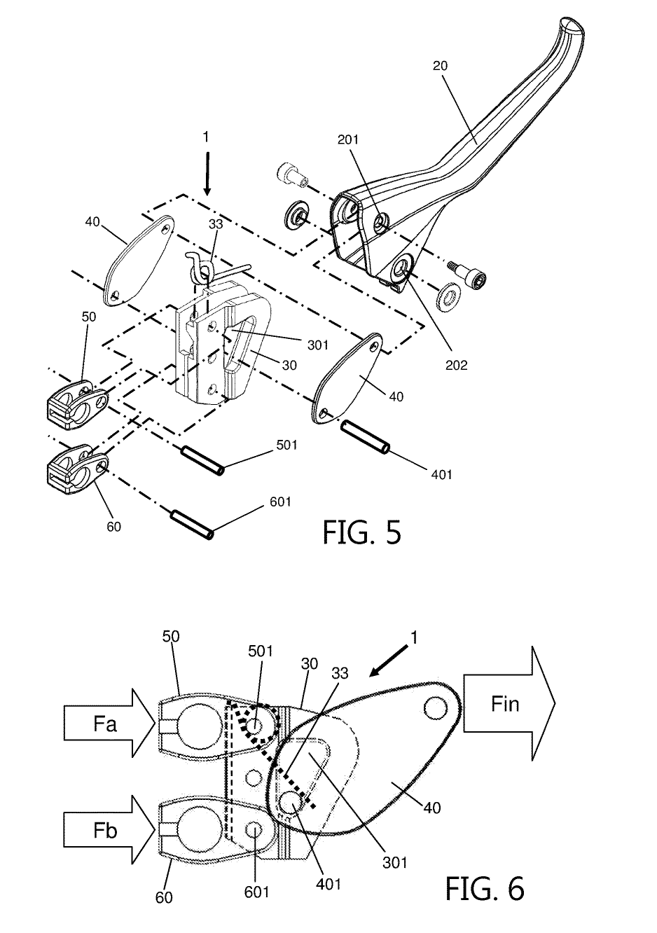

The first structural type of the force-distributing device is called “surface moving pivotal rod type”. Please refer to FIG. 1, FIG. 2, FIG. 5 and FIG. 6. The movable force-in pivotal rod (401) in FIG. 1 and FIG. 2 moves in sliding mode, while the movable force-in pivotal rod (401) in FIG. 5 and FIG. 6 moves in rolling mode. Because these two moving modes have the same physical theory and function, only the force-distributing device with the “sliding pivotal rod” would be described hereinafter.

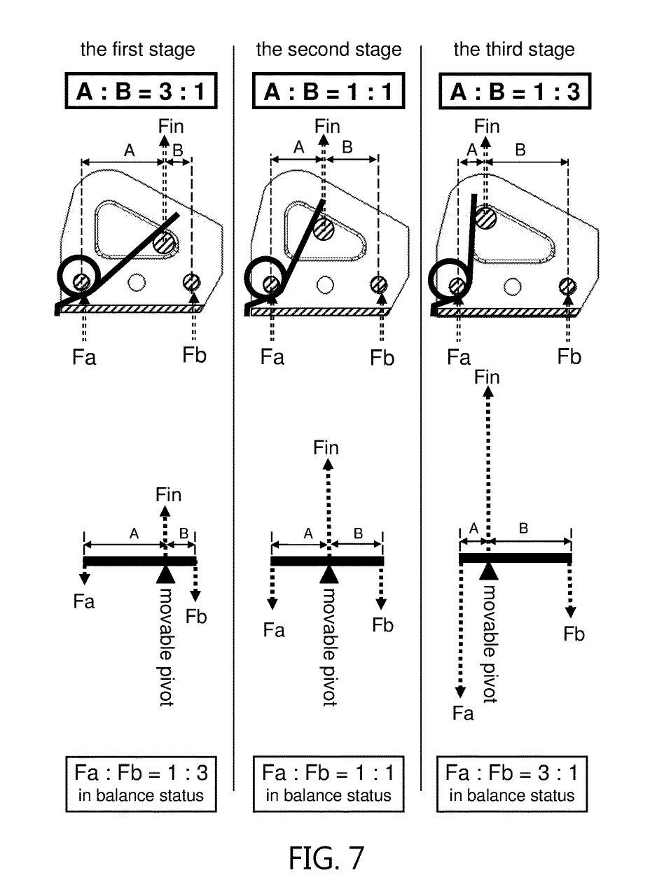

The first structural type of force-distributing device (1) comprising one frame (30), one movable force-in pivotal rod (401), one torsion spring (33), one force input moving piece (40), one first force output moving piece (50) and one second force output moving piece (60). The first force output moving piece (50) pin joint to one side of the frame (30) by a first force output shaft (501), the second force output moving piece (60) pin joint to the opposite side of frame (30) by a second force output shaft (601). The frame (30) forms a rod moving space (301) to accommodate the movable force-in pivotal rod (401) between these two sides of frame (30). The movable force-in pivotal rod (401) formed on one side of the force input moving piece (40) contacts the surface of the rod moving space (301). The torsion spring (33) is mounted inside the frame (30) by jacketing the first force output shaft (501) and by fixing one tail on frame (30) and attaching the other tail on the movable force-in pivotal rod (401). The force input from the force input moving piece (40) is transferred to the frame (30) via movable force-in pivotal rod (401). Then the input force should be divided into two force outputs of the first force output shaft (501) and the second force output shaft (601) via the frame (30). Lastly, the two divided forces are separately transferred to the first force output moving piece (50) and the second force output moving piece (60). The amounts of the two force outputs depend on the position of the position of the movable force-in pivotal rod (401) because the movable force-in pivotal rod (401), the first force output shaft (501) and the second force output shaft (601) are pin jointed by frame (30). The structural relationship of them forms a force balancing between a moving fulcrum and two ends of a lever. The force balancing is illustrated in FIG. 7. When the force input applied from 0 and start to increase, the movable force-in pivotal rod (401) cannot yet move due to the counteracting torque of the torsion spring (33). Therefore, the forces distributed of the first force output shaft (501) and the second output force shaft (601) keep at 1:3 fixed ratio. This status is called “the first stage”. When the force input increases and generate a sufficient torque exceeding the counteracting torque of the torsion spring (33), the movable force-in pivotal rod (401) starts to move along the attached surface, and the force distribution ratio of the first force output shaft (501) and second force output shaft (601) starts to change. Now, the status is entering “the second stage”, the force distributed to the first force output shaft (501) gradually increases and the force distributed to second force output shaft (601) gradually decreases. When the movable force-in pivotal rod (401) move to its final position, the force distribution of the first force output shaft (501) and the second force output shaft (601) is fixed at 3:1 ratio, and the status enters “the third stage”.

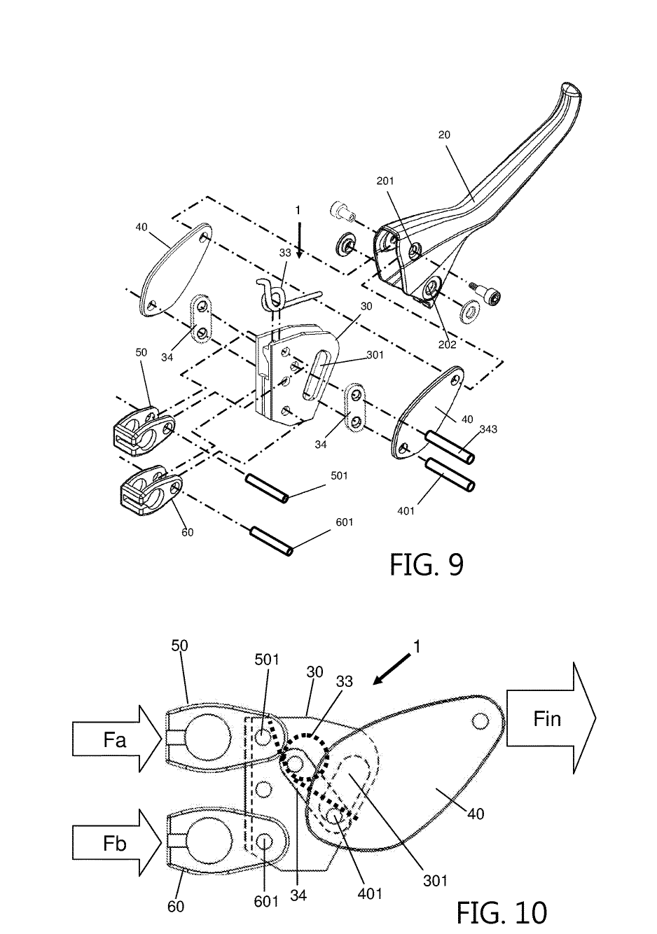

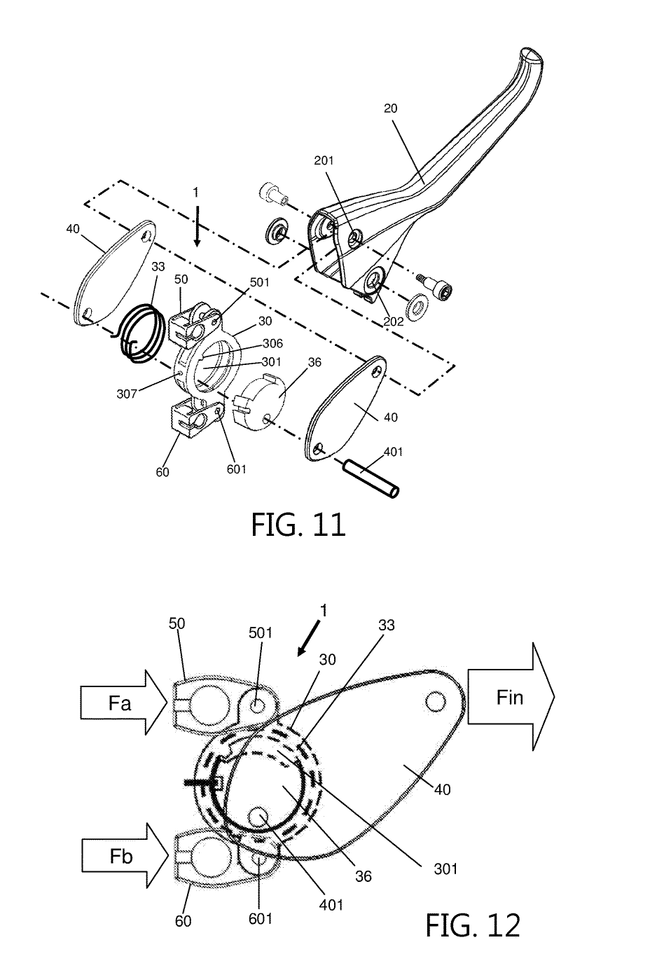

The second structural type of the force-distributing device is called “rotating pivotal rod type”. Please refer to FIG. 9 to FIG. 12. In the illustration of FIG. 9 and FIG. 10, the movable force-in pivotal rod (401) rotates along with a rotating arm (34). In the illustration of FIG. 11 and FIG. 12, the movable force-in pivotal rod (401) rotates along with the rotating body (36). Because these two types of rotation have the same physical theory and function, only the force-distributing device with the “rotating arm pivotal rod” would be described hereinafter.

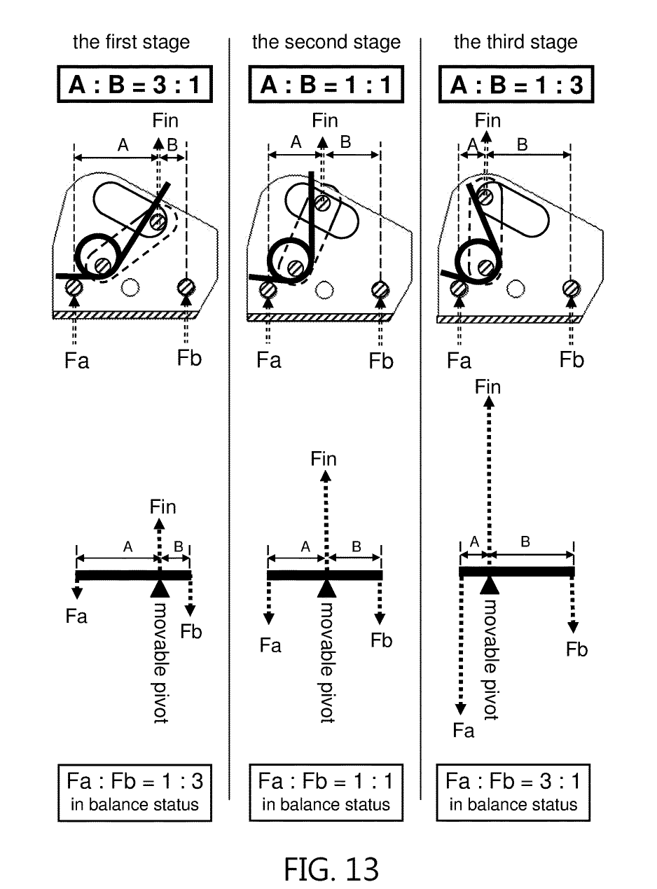

Comparing the first structural type and the second structural type of the force-distributing device, both of them include the same of one frame (30), one movable force-in pivotal rod (401), one torsion spring (33), one force input moving piece (40), one first force output moving piece (50) and one second force output moving piece (60). But the second structural type comprising one extra rotating arm (34). The first force output moving piece (50) pin joint to one side of the frame (30) by a first force output shaft (501), the second force output moving piece (60) pin joint to the opposite side of frame (30) by a second force output shaft (601). The frame (30) forms a rod moving space (301) to accommodate the movable force-in pivotal rod (401) between these two sides of frame (30). The movable force-in pivotal rod (401) is formed on one side of the force input moving piece (40). One end of the rotating arm (34) pin joint to the rod moving space (301) via the movable force-in pivotal rod (401) while the other end of the rotating arm (34) pin joint to the frame (30) by a rotating arm shaft (343). The torsion spring (33) is mounted inside the frame (30) by jacketing the rotating arm shaft (343) and by fixing one tail on frame (30) and attaching the other tail on the movable force-in pivotal rod (401). The force input moving piece (40) introduce the force input through the movable force-in pivotal rod (401) to one side of the rotating arm (34) and generate a count-clockwise torque around the rotating arm shaft (343), but the torsion spring (33) also generate a clockwise torque rotating around the rotating arm shaft (343). When the count-clockwise torque applied not yet exceeds the clockwise torque applied from the torsion spring (33), the rotating arm (34) does not rotate. The movable force-in pivotal rod (401) also does not move. Only when the force input increase and generate a sufficient count-clockwise torque exceeding the clockwise torque, the rotating arm (34) starts to rotate and the movable force-in pivotal rod (401) starts to move. Therefore, the movable force-in pivotal rod (401) can transfer the force input from the force input moving piece (40) to the frame (30) via the structural combination of the torsion spring (33), the rotating arm (34) and the rotating arm shaft (343). Then the frame (30) divide the force input into two force outputs to the first force output shaft (501) and the second force output shaft (601). Finally, the two force outputs can each go through first force output moving piece (50) and the second force output moving piece (60). The amounts of the two force outputs depend on the position of the position of the movable force-in pivotal rod (401) because the movable force-in pivotal rod (401), the first force output shaft (501) and the second force output shaft (601) are pin jointed by frame (30). The structural relationship of them forms a force balancing between a moving fulcrum and two ends of a lever. Please refer to FIG. 13 for the force balancing illustration. When the force input applied from 0 and start to increase, the movable force-in pivotal rod (401) cannot yet move due to the counteracting torque of the torsion spring (33). Therefore, the forces distributed on the first force output shaft (501) and the second output force shaft (601) keep at 1:3 fixed ratio. This status is called “the first stage”. When the force input increases and generate a sufficient torque exceeding the counteracting torque of the torsion spring (33), the movable force-in pivotal rod (401) starts to move along the attached surface, and the force distribution ratio of the first force output shaft (501) and second force output shaft (601) starts to change. Now, the status is entering “the second stage”, the force distributed to the first force output shaft (501) gradually increases and the force distributed to second force output shaft (601) gradually decreases. When the movable force-in pivotal rod (401) move to its final position, the force distribution of the first force output shaft (501) and the second force output shaft (601) is fixed at 3:1 ratio, and the status enters “the third stage”.

In summary of the explanations above, the second structural type force-distributing device has the same three stages of force distribution function and is also suitable for single-handed front and rear wheels brake device. It offers better safety and efficiency compared to traditional two-hands separate brake devices for front wheel and rear wheels.

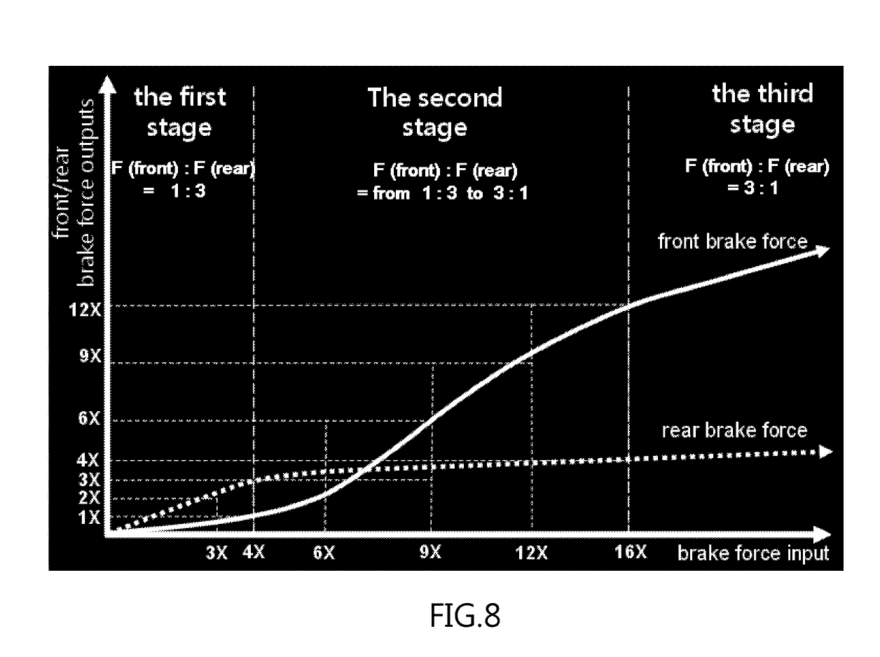

The first type of embodiment of the force-distributing device can be referred to FIG. 1 to FIG. 4 and combine with a “cable brake lever” assembly. This embodiment comprising one frame assembly (10), one brake lever (20) and one “surface moving pivotal rod type” force-distributing device (1). The frame assembly (10) forms one fixed section (101) to be fixed on the handlebar (70) and a container space to house related parts. One side of the frame assembly (10) setup two sets of cable adjustment screw assembly (12) to be put through by a front brake cable (52) and a rear brake cable (62). The other side of the frame assembly 10 pin joint to a shaft hole (202) of the brake lever (20). The force input end of the force input moving piece (40) pin joint to the brake lever's force output hole (201), the first force output moving piece (50) connects to the front brake cable (52) and the rear brake force moving piece (60) connects to the rear brake cable (62). With the above combination, when user apply a braking force to the brake lever (20), the braking force passing through the movable force-in pivotal rod (401) then to the frame (30). As the braking force gradually increase, the movable force-in pivotal rod (401) start to move gradually towards to its final position, thus alters the force distribution ratio. Finally, it provides the force distribution function between front and rear wheels illustrated in FIG. 8 and builds a great braking process with safe, smooth, reliable, and quick to stop function.

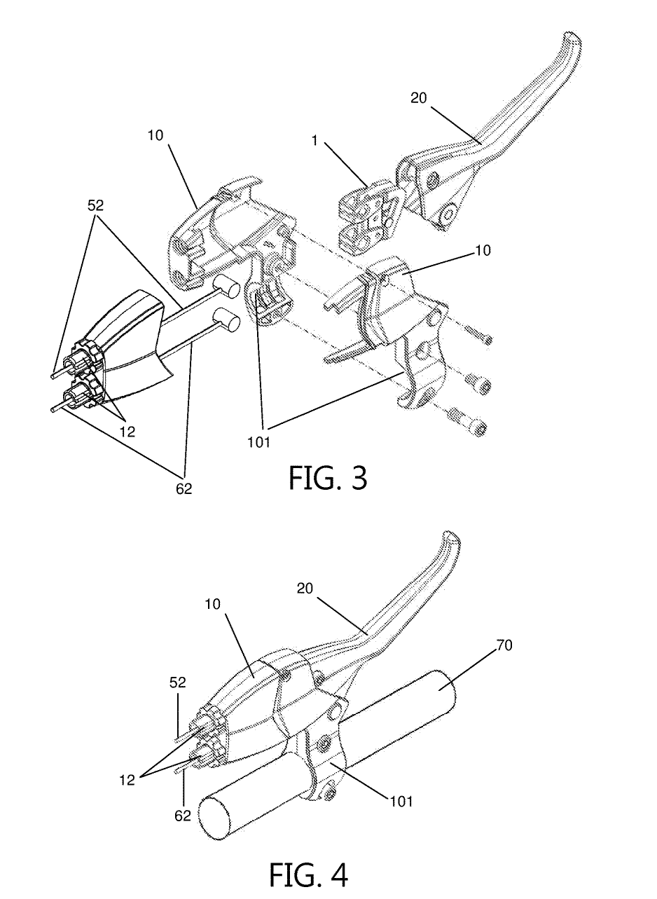

The second type of embodiment of the force-distributing device can be referred to FIG. 3 to FIG. 6 and combine with a “cable brake lever” assembly. This embodiment is almost identical to the first type single-handed front and rear wheel brake device, including one frame assembly (10), one brake lever (20) and one “rotating pivotal rod type” force-distributing device (1). However, except the “rotating pivotal rod type” force-distributing device (1), the mechanism including physical theory, function of single-handed front and rear wheel brake, combined characteristics and exterior are all identical, therefore the details will not be repeated.

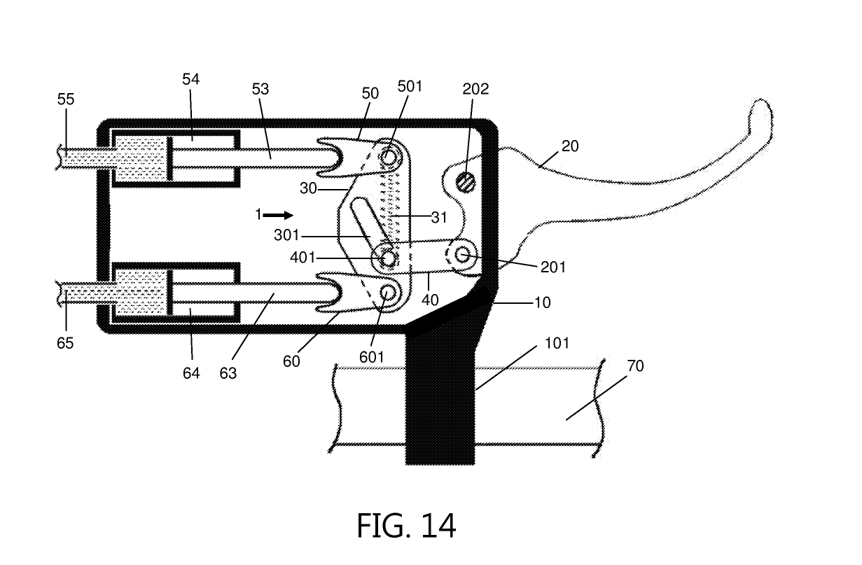

The third type of embodiment of the force-distributing device can be referred to FIG. 14 and combine with a “hydraulic brake lever” assembly. This embodiment comprising one frame assembly (10), one brake lever (20), one front brake hydraulic piston rod (53), one rear brake hydraulic piston rod (63), one front brake hydraulic cylinder (54), one rear brake hydraulic cylinder (64) and one “surface moving pivotal rod type” force-distributing device (1). The frame assembly (10) forms one fixed section (101) to be fixed on a handlebar (70) and a container space to house related parts. One side of the frame assembly (10) setup two holes to put through a front brake hydraulic pipe (55) and a rear brake hydraulic pipe (65), the other side pin joint to a lever shaft hole (202) of the brake lever (20). The force input end of the force input moving piece (40) pin joint to a lever force output hole (201) of the brake lever (20). The front brake force output moving piece (50) and the rear brake force moving piece (60) each connects to the front brake hydraulic piston rod (53) and the rear brake hydraulic piston rod (63). The front brake hydraulic piston rod (53) and the rear brake hydraulic piston rod (63) then each drives the responding piston inside of the front brake hydraulic cylinder (54) and the rear brake hydraulic cylinder (64). Each hydraulic cylinder's output port connects to the front brake hydraulic pipe (55) and the rear brake hydraulic pipe (65). With the above combination, when user apply a brake force to the brake lever (20), the braking force passing through the movable force-in pivotal rod (401) then to the frame (30). As the braking force gradually increase, the movable force-in pivotal rod (401) starts to move from starting position to the final position of the rod moving space (301) and the force-distributing device (1) follows the described mechanism to divide the braking force into two separate force outputs that each go through a passing way of “the front brake force output shaft (501)-->the front brake force output moving piece (50)-->the front brake hydraulic piston rod (53)-->the front brake hydraulic cylinder (54)-->the front brake hydraulic pipe (55)” and another passing way of “the rear brake force output shaft (601)-->the rear brake force moving piece (60)-->the rear brake hydraulic piston rod (63)-->the rear brake hydraulic cylinder (64)-->the front brake hydraulic pipe (65)”. Finally, the force distribution curve between front and rear wheels illustrated in FIG. 8 showing a great braking process with safe, smooth, reliable, and quick to stop function.

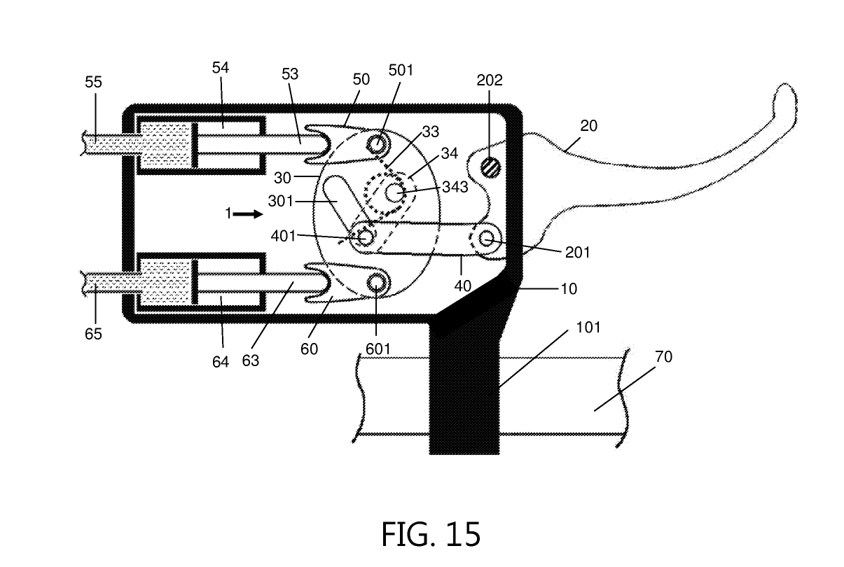

The fourth type of embodiment of the force-distributing device can be referred to FIG. 15 and combine with a “hydraulic brake lever” assembly. This embodiment is almost identical to the third type of embodiment, it also comprising one frame assembly (10), one brake lever (20), one front brake hydraulic piston rod (53), one rear brake hydraulic piston rod (63), one front brake hydraulic cylinder (54), one rear brake hydraulic cylinder (64), one front brake hydraulic pipe (55), one rear brake hydraulic pipe (65) and one “rotating pivotal rod type” force-distributing device (1). However, except the “rotating pivotal rod type” force-distributing device, the mechanism including physical theory, function of single-handed front and rear wheel brake, combined characteristics and exterior are all identical, therefore the details will not be repeated.

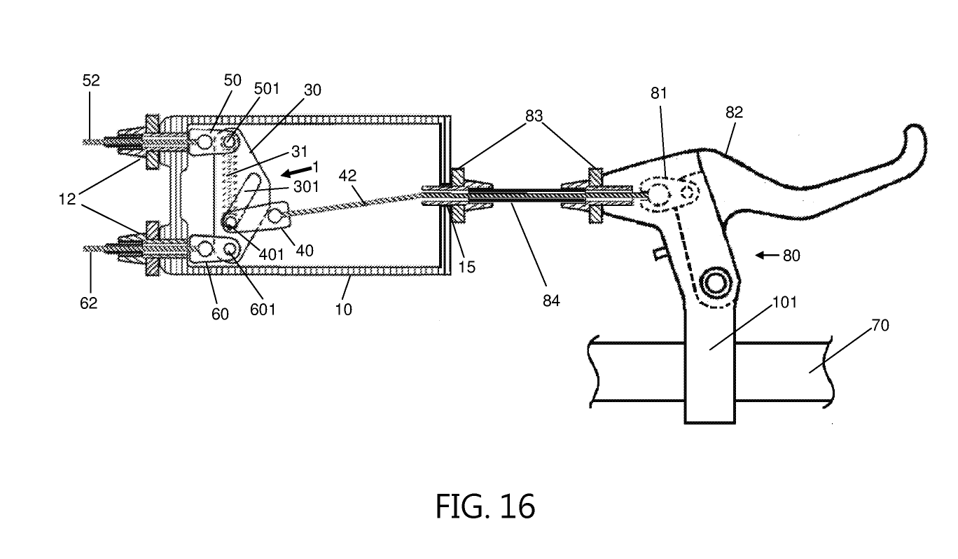

The fifth type of embodiment of the force-distributing device can be referred to FIG. 16 and combine with a “cable brake breakout box” assembly. This embodiment comprising one frame assembly (10), one brake force input cable (42) and one “surface moving pivotal rod type” force-distributing device (1). The frame assembly (10) forms a container space to house related parts. One side of the frame assembly (10) setup two sets of cable adjustment screw assembly (12) to be put through by a front brake cable (52) and a rear brake cable (62). The other side of the frame assembly 10 forms a connecting hole (15) to setup a cable adjustment screw assembly (83), the brake force input cable (42) is put through the existing cable adjustment screw assembly (83), the force input moving piece (40) connects to one end of the brake force input cable (42), the other end of the brake force input cable (42) connects to the existing cable fastener (81) of the existing cable brake lever assembly (80). The first force output moving piece (50) connects to the front brake cable (52), the second force output moving piece (60) connects to the rear brake cable (62). With the combination described as above, when user start to apply force to the existing brake lever (82), the brake force passes through the brake force input cable (42) and pulling the force input moving piece (401) and movable force-in pivotal rod (401) inside the frame assembly (10). As the brake force gradually increases, the movable force-in pivotal rod (401) starts to move from starting position to the final position of the rod moving space (301) and the force-distributing device (1) follows the described mechanism to divide the braking force into two separate force outputs that each go through a passing way of “The front brake force output shaft (501)-->the front brake force output moving piece (50)-->the front brake cable (52)” and another passing way of “the rear brake force output shaft (601)-->the rear brake force moving piece (60)-->the rear brake cable (62)”. Finally, it provide the force distribution function between front and rear wheels illustrated in FIG. 8 and also build the three-stage safe brake feature.

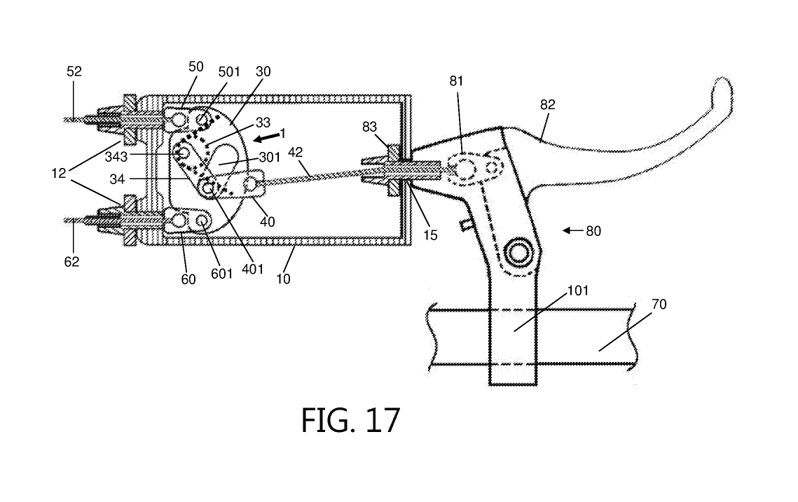

The sixth type of embodiment of the force-distributing device can be referred to FIG. 17 and combine with a “cable brake breakout box” assembly. This embodiment is identical to the fifth type of embodiment except using the “rotating pivotal rod type” force-distributing device (1). However, their mechanisms are all identical, therefore the details will not be repeated.

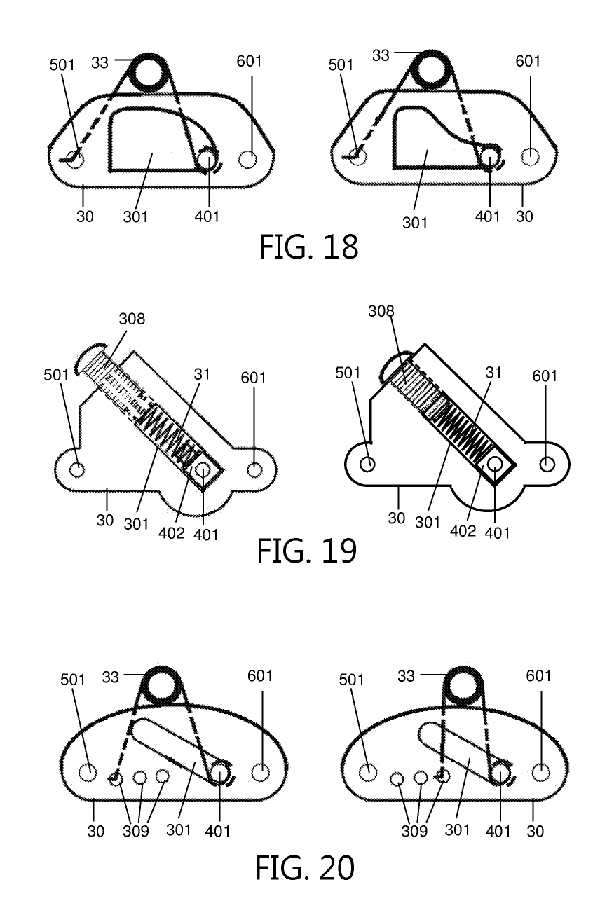

Further, as the FIG. 18, FIG. 19 and FIG. 20 illustrated, the detail characteristics of force-distributing device can be adjusted with methods as described below.

The first method to change the detail characteristics of the force distribution is to design a different shape of the rod moving space (301) to change the contacting track of the movable force-in pivotal rod (401). For example, please refer to FIG. 18 describing two different shapes of the rod moving space (301), as the left shape of the rod moving space (301) can result the dynamic force-distributing device to enter the “second stage” status earlier, on the contrary, the right shape of the rod moving space (301) can delay the time entering the “second stage” status.

The second method of adjustment setup is to change the transformation volume of the spring. As the volume of the transformation changes, the profile of the “three stages dynamic force distribution curve” must change immediately. For example, please refer to FIG. 19 and FIG. 20 for two different adjustment mechanics. The FIG. 19 setup a screw adjustment mechanics, while the FIG. 20 illustrate multiple attachment holes for spring to be fixed in any of the holes. However, any existing spring adjustment available can all be applied to these two types of force-distributing device described herein.

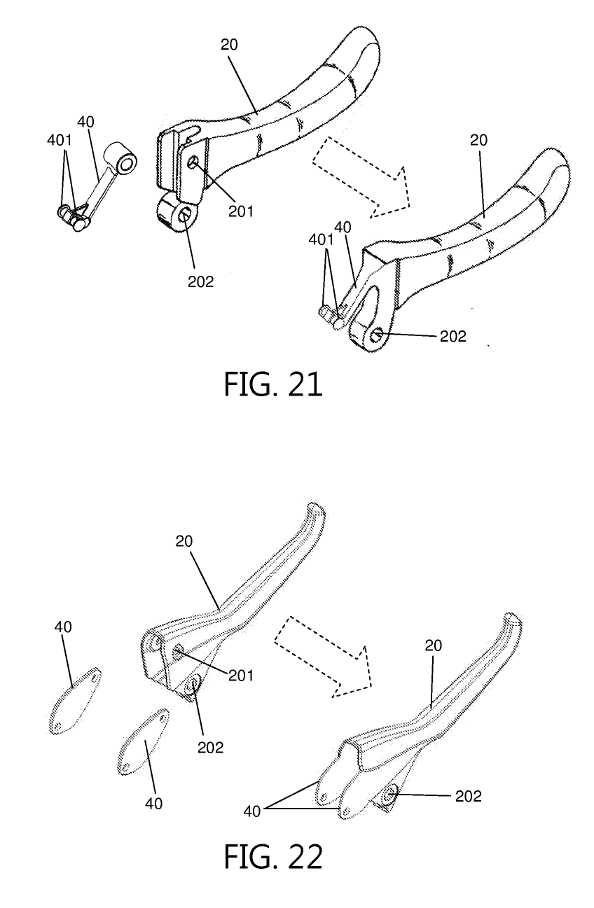

More as illustrated in FIG. 21 and FIG. 22, the force input moving piece (40) and the lever (20) can be combined to form a composite lever to simplify the structure of the single-handed brake device.

1. A dynamic force distribution device comprising:
a frame;
a movable force input pivotal rod;
a spring;
a force input moving piece;
a first force output moving piece;
a second force output moving piece;
wherein the first force output moving piece pin joint to one side of the frame, the second force output moving piece pin joint to the opposite side of frame, the frame forms a space to accommodate the movable force-in pivotal rod between these two sides of frame, a movable force-in pivotal rod formed on one side of the force input moving piece contacts the surface of the rod moving space, the spring is mounted inside the frame by fixing one tail on frame and attaching the other tail on the movable force-in pivotal rod.

2. A dynamic force distribution device comprising:
a frame;
a movable force input pivotal rod;
a spring;
a force input moving piece;
a first force output moving pieces;
a second force output moving pieces;
a rotating arm;
wherein the first force output moving piece pin joint to one side of the frame, the second force output moving piece pin joint to the opposite side of frame, the frame forms a rod moving space to accommodate a movable force-in pivotal rod between these two sides of frame, the movable force-in pivotal rod is formed on one side of the force input moving piece, one end of the rotating arm pin joint to the rod moving space via the movable force-in pivotal rod while the other end of the rotating arm pin joint to the frame, the spring is mounted inside the frame by fixing one tail on frame and attaching the other tail on the movable force-in pivotal rod.

3. As the dynamic force-distributing device described in claim 1, the dynamic force-distributing device is applied on a single-handed braking device of front and rear wheels which comprising:
a dynamic force-distributing device;
a frame;
a brake lever;
wherein the frame form a fixed section to be fixed and form a space to house related parts, one side of the frame setup two sets of cable adjustment screw assembly to be put through by a front brake cable and a rear brake cable, the other side of the frame pin joint to the brake lever, one end of the force input moving piece pin joint to the brake lever, the first force output moving piece connect to the front brake cable and the rear brake force moving piece connect to the rear brake cable.

4. As the dynamic force-distributing device described in claim 2, the dynamic force-distributing device is applied on a single-handed braking device of front and rear wheels which comprising:
a dynamic force-distributing device;
a frame;
a brake lever;
wherein the frame form a fixed section to be fixed and form a space to house related parts, one side of the frame setup two sets of cable adjustment screw assembly to be put through by a front brake cable and a rear brake cable, the other side of the frame pin joint to the brake lever, one end of the force input moving piece pin joint to the brake lever, the first force output moving piece connect to the front brake cable and the rear brake force moving piece connect to the rear brake cable.

5. As the dynamic force-distributing device described in claim 1, the dynamic force-distributing device is applied on a single-handed braking device of front and rear wheels which comprising:
a dynamic force-distributing device;
a frame;
a brake lever;
a front brake hydraulic piston rod;
a rear brake hydraulic piston rod;
a front brake hydraulic cylinder;
a rear brake hydraulic cylinder;
wherein the frame form a fixed section to be fixed and form a space to house related parts, one side of the frame setup two holes to put through a front brake hydraulic pipe and a rear brake hydraulic pipe individually, the other side of the frame pin joint to the brake lever, the force input moving piece pin joint to the brake lever, the front brake force output moving piece and the rear brake force moving piece individually connect to the front brake hydraulic piston rod and the rear brake hydraulic piston rod, the front brake hydraulic piston rod and the rear brake hydraulic piston rod individually drive the responding piston of the front brake hydraulic cylinder and the rear brake hydraulic cylinder, each hydraulic cylinder's output port connect to the front brake hydraulic pipe and the rear brake hydraulic pipe.

6. As the dynamic force-distributing device described in claim 2, the dynamic force-distributing device is applied on a single-handed braking device of front and rear wheels which comprising:
a dynamic force-distributing device;
a frame;
a brake lever;
a front brake hydraulic piston rod;
a rear brake hydraulic piston rod;
a front brake hydraulic cylinder;
a rear brake hydraulic cylinder;
wherein the frame form a fixed section to be fixed and form a space to house related parts, one side of the frame setup two holes to put through a front brake hydraulic pipe and a rear brake hydraulic pipe individually, the other side of the frame pin joint to the brake lever, the force input moving piece pin joint to the brake lever, the front brake force output moving piece and the rear brake force moving piece individually connect to the front brake hydraulic piston rod and the rear brake hydraulic piston rod, the front brake hydraulic piston rod and the rear brake hydraulic piston rod individually drive the responding piston of the front brake hydraulic cylinder and the rear brake hydraulic cylinder, each hydraulic cylinder's output port connect to the front brake hydraulic pipe and the rear brake hydraulic pipe.

7. As the dynamic force-distributing device described in claim 1, the dynamic force-distributing device is applied on a single-handed braking device of front and rear wheels which comprising:
a dynamic force-distributing device;
a frame body;
a force input cable;
wherein the frame forms a space to house related parts, one side of the frame setup two sets of cable adjustment screw assembly to be put through by a front brake cable and a rear brake cable individually, the other side of the frame setup a cable adjustment screw assembly, the brake force input cable is put through the existing cable adjustment screw assembly, the force input moving piece connect to one end of the brake force input cable, the other end of the brake force input cable connect to the existing cable fastener of the existing cable brake lever assembly, the first force output moving piece connect to the front brake cable, the second force output moving piece connects to the rear brake cable.

8. As the dynamic force-distributing device described in claim 2, the dynamic force-distributing device is applied on a single-handed braking device of front and rear wheels which comprising:
a dynamic force-distributing device;
a frame body;
a force input cable;
wherein the frame forms a space to house related parts, one side of the frame setup two sets of cable adjustment screw assembly to be put through by a front brake cable and a rear brake cable individually, the other side of the frame setup a cable adjustment screw assembly, the brake force input cable is put through the existing cable adjustment screw assembly, the force input moving piece connect to one end of the brake force input cable, the other end of the brake force input cable connect to the existing cable fastener of the existing cable brake lever assembly, the first force output moving piece connect to the front brake cable, the second force output moving piece connects to the rear brake cable.

9. As the dynamic force-distributing device described in claim 1, the dynamic force-distributing device setup a mechanics of the deformation adjustment of spring in order to change the force distribution characteristics of the dynamic force-distributing device.
